(19) United States
(12) Patent Application Publication
(10) Pub. No.: US 2021/0155526 A1
(43) Pub. Date: May 27, 2021

(54) PLASMA FIBERIZATION

(71) Applicant: Unifrax I LLC, Tonawanda, NY (US)

(72) Inventors: Chad D. CANNAN, Spring, TX (US); Mauricio Munhoz DE SOUZA, Amherst, NY (US); Michael J. ANDREJCAK, Buffalo, NY (US); Dillan R. SAYERS, North Tonawanda, NY (US); Jeffrey RIPSON, Youngstown, NY (US); Mark TRAVERS, Ransomville, NY (US)

(21) Appl. No.: 16/970,000

(22) PCT Filed: Jul. 14, 2020
(86) PCT No.: PCT/US20/41894

§ 371 Date: Aug. 14, 2020

Related U.S. Application Data
(60) Provisional application No. 62/874,182, filed on Jul. 15, 2019.

(51) Int. Cl. C03B 37/01

(52) U.S. Cl. CPC C03B 37/01; H05H 1/26

(57) ABSTRACT

A method of producing fibers includes exposing an inorganic composition to a plasma plume, where the plasma plume has a temperature of at least 1500° C. and a bulk velocity of at least 350 m/s. A system for producing fibers includes a plasma torch to produce the plasma plume and a feeding device to introduce the inorganic composition to the plasma plume.

### TECHNICAL FIELD

The present disclosure generally relates to fiberization of compositions using a source of high temperature and high velocity plasma jets. More particularly, the present disclosure relates to simultaneous melting, atomization, and fiberization of inorganic formulations using plasma torches.

### BACKGROUND

The transformation of an inorganic formulation into fibers generally involves two steps. Namely, a melting step and a fiber attenuation step. In the melting step, it is necessary to transform all the solid raw materials of the inorganic formulation into a melted material. That is, the inorganic formulation must be heated to or above the melting point of the inorganic formulation. This may be achieved, e.g., by using a furnace, such as an electric or gas furnace. The melting point of the inorganic formulation varies depending on the components thereof. For example, in the case of forming ceramic fibers, the starting formulation could have a melting point of >1800° C.

Once the inorganic formulation has been melted, the attenuation step transforms the melted material into fibers. This step may also be referred to as a fiberization step. There are several ways of transforming a melted material into fibers, all of which involve the application of kinetic energy to attenuate the melted material into fibers. In one process, the melted material is exposed to a blast of compressed air with extremely high speed (<700 m/s), also known as an air blowing method. This kinetic energy atomizes the melted material and transforms droplets of the melted material into fibers. FIG. 2 shows a photo of this process. In FIG. 2, it is possible to see the attenuation of the droplets into fibers, as the droplets are blown from the left of FIG. 2 into fibers on the right.

Other common processes for attenuation or fiberization include spinning through internal or external centrifuging, flame attenuation, and the like. In some flame attenuation processes, e.g., a pot-and-marble process, very tiny strands of glass (i.e., generally, less than 0.5 mm in diameter) are first continuously drawn through a plurality of orifices at the bottom of a bushing melter, and then guided to a high-velocity flame (<1000 m/s) from a combustion burner, thereby transforming the glass strands into fibers. In general, the burner combusts natural gas with air (possibly enriched with oxygen) or combusts oxyhydrogen. However, because this process uses an alloy bushing melter and a combustion burner, it can only be used to melt inorganic mixes with relatively low melting temperature (i.e., having a melting point of 1400° C. or less) and often the glass fibers produced can only be used at relatively low temperature (e.g. in the applications with temperature less than 650° C.). Further, this process is limited to materials that can be readily formed into thin glass strands without devitrification, which excludes materials of poor glass formability such as some refractory alumina silicate, magnesia silicate, and calcia silicate compositions, which are difficult or impossible to form into continuous glass strands.

In comparison to the conventional fiberization methods with at least two or multiple steps, the method of the present disclosure is capable of simultaneous melting, atomization and fiberization of inorganic formulation by using plasma torches that provide high temperature and high velocity plasma jets.

The melt viscosity characteristic (strong vs. fragile) is often characterized by the degree of deviation of log (viscosity) versus Tg/T (T is temperature, Tg is the glass transition temperature) from the linear Arrhenius behavior. An ideal strong melt, e.g. molten silica, presents a straight line behavior between its log (viscosity) and Tg/T, whereas a more fragile melt, e.g. the inorganic formulations of typical ceramic fibers, significantly deviates from a straight line. In other words, given the same relative temperature (Tg/T), a fragile melt has significantly lower viscosity than a strong melt. Despite the variety of commercially available fiberization technologies, there does not exist a single fiberization technology that is able to fiberize materials of a broad range of melt viscosity characteristics from “strong” melts to “fragile” melts, and a broad range of melting points from very high temperature (i.e., >2000° C.) to low temperature (i.e., <1200° C.). For instance, internal centrifuging fiberization methods (e.g., a rotary fiberization process) are generally limited to materials with a fiberization temperature not exceeding the use temperature of the rotary fiberizer materials (typically an alloy with use temperature<1200° C.), the materials having suitable viscosity (e.g., about 1000 poise) at fiberization temperature and having a sufficiently wide window (e.g., >100° C.) between the liquidus and fiberization temperatures. External centrifuging with spinning wheels and air blowing methods that use a sub-emerged electrode furnace (“SEF”) can produce fibers from materials with very high melting temperature (e.g., >2000° C.). However, these methods can fiberize the melts only at low viscosity (e.g., <100 poise), and thus are not applicable to fiberize strong melts with very high viscosity even at high temperature (e.g., a high-purity silica melt may have a viscosity of >10⁵ poise even at 2000° C.). Moreover, the products made by these methods often include a large amount (>30 wt %) of unfiberized particulates (“shot”). On the other hand, the method of the present disclosure is able to fiberize materials across a broad range of melt characteristics, including, but not limited to, materials having low melting temperature and low viscosity, materials having low melting temperature but high viscosity, materials having high melting temperature and low viscosity, and materials having high melting temperature and high viscosity. Further, the method according to the present disclosure is capable of producing a fiberized product with very little shot, as described in more detail herein.

In addition, fiberization methods such as high-velocity air blowing, internal centrifuging, and external centrifuging produce fibers with average diameter in the range of 1.5-8 μm but are incapable of producing fibers with finer diameters. Flame attenuation methods are able to produce fibers with an average diameter of less than 1 μm but are limited to materials with lower melting temperature. Conversely, the method according to the present disclosure is able to produce fibers having a very fine fiber diameter (<1 μm), even across the wide range of materials discussed above.

Moreover, as compared with methods in which combustion is used for the heat source, the present method may employ a plasma torch. As such, the present method is able to eliminate CO and NOₓ emissions.

### BRIEF DESCRIPTION OF THE DRAWINGS

FIG. 1 is a diagrammatic illustration of a system for producing fibers according to an embodiment of the present disclosure.

FIG. 2 is a photograph of an air blowing method.

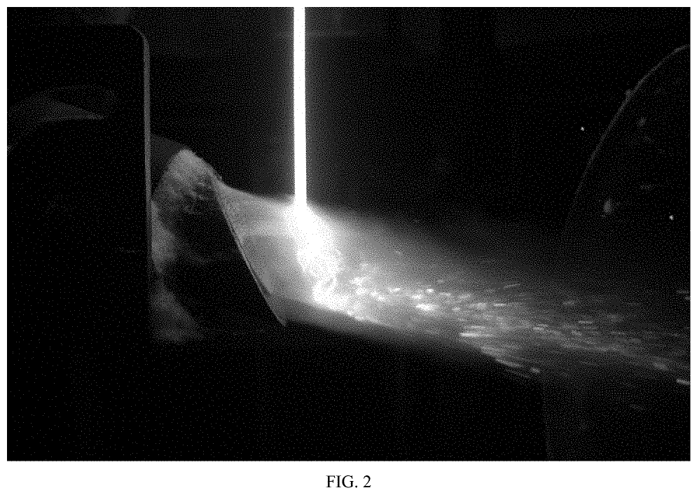

FIG. 3A is a photograph of a system for producing fibers according to an embodiment of the present disclosure.

FIG. 3B is a photograph of a system for producing fibers according to an embodiment of the present disclosure.

FIG. 4A is an SEM photograph of fibers produced according to an embodiment of the present disclosure.

FIG. 4B is an SEM photograph of fibers produced in a comparative example.

FIG. 5 is a graph of temperature dependence of viscosity of the melt of various inorganic formulations useful in the present disclosure.

FIG. 6 is a graph of fiber diameter distribution observed in Example 2.

FIG. 7 is a graph of fiber diameter distribution observed in Example 3.

FIG. 8 is an SEM photograph of fibers produced according to an embodiment of the present disclosure.

### DETAILED DESCRIPTION

The following descriptions are provided to explain and illustrate embodiments of the present disclosure. The described examples and embodiments should not be construed to limit the present disclosure.

According to embodiments of the present disclosure, a source of high temperature and high velocity, such as a plasma torch, is used to transform an inorganic formulation into fibers (i.e., “fiberized”). As used herein, the term “fiber” may refer to a structure having a diameter of at most 50 microns and an aspect ratio of at least 3, or a structure having an aspect ratio of at least 5, or a structure having an aspect ratio of at least 10. The term “fiberized”, as used herein, refers to forming a material into one or more fibers. In some embodiments, the inorganic formulation may be introduced to the source of high temperature and high velocity as a solid, and the inorganic formulation is fiberized in a single step. In alternative embodiments, the inorganic formulation may be partially or wholly melted prior to exposure to the source of high temperature and high velocity.

A plasma torch (also referred to as a plasma arc, plasma gun, or plasma cutter) is a device capable of generating a directed flow of plasma, i.e., a plasma plume or plasma jet. The plasma plume is a high temperature jet and is produced by ionizing a gas through subjecting the gas to an electrical discharge. The plasma torch can employ several different types of gas. For instance, suitable gases include, but are not limited to, oxygen, nitrogen, argon, helium, air, hydrogen, or mixtures thereof. In some embodiments, argon alone may be employed, or a mixture of argon and helium may be employed. Any mixture of argon and helium may be employed, e.g., those in which a ratio of argon to helium is from 100 to 0.01, from 50 to 0.02, from 10 to 0.1, from 5 to 0.2, from 2 to 0.5, from 2.5 to 0.8, or from 1.25 to 0.8.

Depending on the settings on the plasma torch (e.g., type of gas, gas mixing ratio, flow-rate of the gas, power supplied, nozzle design, etc.), the plasma torch may deliver a plasma plume with different properties such as speed, heat transfer, temperature, size, etc. The settings may be appropriately adjusted to provide the desired properties of the plasma plume, e.g., depending on the application. For example, in some instances, the type of gas used depends on the melting point of the inorganic formulation. In some embodiments, the gas may include a composition that is incorporated into or deposited onto the fibers. For instance, nitrogen gas supplied to the plasma torch may provide fibers having a nitrided surface.

The temperature of the plasma plume may reach up to 10000° C. or greater, e.g., at least 2000° C., at least 3000° C., at least 4000° C., at least 5000° C., at least 6000° C., at least 7000° C., at least 8000° C., at least 9000° C., or at least 10000° C. The plasma plume speed (i.e., bulk velocity) may vary. In some instances, the plasma plume speed may be as high as 5000 m/s or more, e.g., at least 350 m/s, at least 500 m/s, at least 600 m/s, at least 700 m/s, at least 800 m/s, at least 900 m/s, at least 1000 m/s, at least 1100 m/s, at least 1200 m/s, at least 1300 m/s, at least 1400 m/s, at least 1500 m/s, at least 1600 m/s, at least 1700 m/s, at least 1800 m/s, at least 1900 m/s, at least 2000 m/s, at least 2100 m/s, at least 2200 m/s, at least 2300 m/s, at least 2400 m/s, at least 2500 m/s, at least 2600 m/s, at least 2700 m/s, at least 2800 m/s, at least 2900 m/s, at least 3000 m/s, at least 3100 m/s, at least 3200 m/s, at least 3300 m/s, at least 3400 m/s, at least 3500 m/s, at least 3600 m/s, at least 3700 m/s, at least 3800 m/s, at least 3900 m/s, at least 4000 m/s, at least 4100 m/s, at least 4200 m/s, at least 4300 m/s, at least 4400 m/s, at least 4500 m/s, at least 4600 m/s, at least 4700 m/s, at least 4800 m/s, at least 4900 m/s, or at least 5000 m/s.

The power supplied by the plasma torch may vary depending on, e.g., composition and form of the inorganic formulation, mass of the inorganic formulation, and feed rate among other factors. In some embodiments, the power supplied by the plasma torch may be 5 to 1000 kW, 5 to 500 kW, 10 to 100 kW, 20 to 60 kW, or 50 to 60 kW. The feed rate of the inorganic formulation is not particularly limited and may be, e.g., 0.001 to 100 kg/hr, 0.004 to 50 kg/hr, 0.05 to 15 kg/hr, 0.04 to 0.5 kg/hr, or 1 to 10 kg/hr.

In any embodiment, the inorganic formulation may be heated prior to exposure to the plasma torch. For example, the inorganic formulation may be pre-heated to 1000° C., 1500° C., 1750° C., 2000° C., 2250° C., or 2500° C. By pre-heating the inorganic formulation, the inorganic formulation may be fed into the plasma plume at an increased rate as compared with a method not employing pre-heating. As such, the rate of fiberization may be improved while avoiding increased amounts of un-fiberized material (“shot”). The pre-heating may partially or wholly melt the inorganic formulation creating a liquid inorganic formulation. In some embodiments, the liquid inorganic formulation may have a viscosity of greater than 0 to 10¹⁶ poise, 10000 to 10¹⁶ poise, 100 to 10⁷ poise, or greater than 0 to 1000 poise.

In some embodiments, due to the high temperature and speed produced by the plasma torch, melting and attenuation of an inorganic formulation can be achieved in a single step. That is, a solid inorganic formulation subjected to the plasma plume simultaneously melts, atomizes and attenuates into fibers, thereby streamlining the fiber production process. The solid inorganic formulation may be in any suitable form, such as a powder, pellets, a rod, or the like. Further, the solid inorganic formulation may include a uniform composition or may be a mixture of more than one composition. For instance, a uniform composition may be supplied to the plasma plume in the form of glass or ceramic rods, glass or ceramic pellets, glass or ceramic powders, or glass or ceramic multifilaments. On the other hand, a mixture may be supplied to the plasma plume as rods or pellets or powders of multiple chemicals mixed mechanically, or multiple rods of raw materials or pellets of the raw materials, wherein at least two of the rods or pellets have different compositions from one another. The raw materials may include, e.g., silica, magnesia, zirconia, titania, alumina, calcia, baria, alkali oxides or carbonates, boria, iron oxide, beryllia, phosphates, sulphates, carbides, borides, nitrides, silicides, minerals or compounds such as dolomite, wollastonite, enstatite, forsterite, pyroxene, leucite, mullite, kaolinite, kyanite, sillimanite, andalusite etc.

Embodiments of the present disclosure may be applied to inorganic formulations that require high temperature (i.e., have a high melting point) and could not otherwise be fiberized in a single step by, e.g., flame attenuation. For instance, high temperature inorganic formulations may include alumina-silica, alkaline earth oxides-silica (e.g. calcia-silica, magnesia-silica, or calcia-magnesia-silica), alumina-zirconia-silica (AZS), calcia-alumina, alkali oxides-alumina-silica (e.g. potassia-alumina-silica), a high-purity silica (99 wt % or more silica), carbides such as silicon carbide, zirconium carbide, and hafnium carbide, borides such as titanium boride and zirconium boride, and nitrides such as tantalum nitride, niobium nitride, and vanadium nitride. In some embodiments, the inorganic formulation has a melting point of at least 1000° C., at least 1500° C., at least 1750° C., at least 2000° C., at least 2250° C., at least 2500° C., at least 2750° C., at least 3000° C., at least 3250° C., at least 3500° C., at least 3750° C., at least 4000° C., at least 4250° C., at least 4500° C., at least 4750° C., or at least 5000° C.

In other embodiments of the present disclosure, the inorganic formulations may require low temperature (i.e., have a low melting point). For instance, low temperature inorganic formulations may include B-glass, C-glass, E-glass, and the like. In some embodiments, the inorganic formulation has a melting point of at most 4000° C., at most 3750° C., at most 3600° C., at most 3500° C., at most 3250° C., at most 3000° C., at most 2750° C., or at most 2500° C.

Also disclosed herein are fibers produced according to the process described above. The composition of the fibers is not particularly limited. In some embodiments, the fibers may be low bio-persistence (LBP) ceramic fibers including silica and magnesia and calcia. According to the present disclosure, fibers having a smaller diameter may be produced as compared with similar fibers made by conventional methods such as blowing or spinning. Further, the fibers produced have a narrow diameter distribution. For instance, a relative standard deviation (standard deviation/mean×100) of the fiber diameter may be 40% or less, 35% or less, 30% or less, 25% or less, 20% or less, 15% or less, 10% or less, 5% or less, 4% or less, 3% or less, 2% or less, or 1% or less.

In one or more embodiments, the fibers have a geometric mean fiber diameter of less than 4 μm, less than 3.5 μm, less than 3 μm, less than 2.5 μm, less than 2 μm, less than 1.75 μm, less than 1.5 μm, less than 1.25 μm, less than 1 μm, less than 0.5 μm, or less than 0.5 μm.

In some embodiments, the fibers may be formed of high-purity silica, wherein the inorganic formulation contacted with the plasma plume is a high-purity silica composition (e.g., high-purity silica pellets or a high-purity silica rod). High-purity silica fibers of the present disclosure may be finer as compared with conventional high-purity silica fibers, e.g. produced by an acid leaching process or by an oxyhydrogen flame attenuation process. High-purity silica fiber of finer fiber diameter could also be produced by acid leaching of a precursor microfiber, however, the manufacturing difficulty increases with a finer precursor microfiber. On the other hand, the presently disclosed process does not require a leaching process since high-purity silica can be used as the inorganic formulation. As used herein, “high-purity silica” refers to a formulation having a silica content of at least 99 wt %.

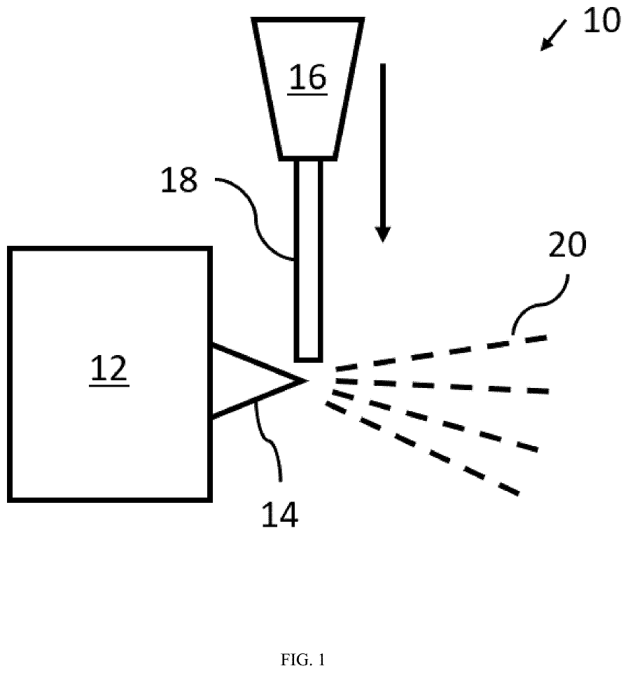

Also disclosed herein is a fiberization system including a plasma torch (e.g., the plasma torch described above) configured to fiberize an inorganic formulation (e.g., the inorganic formulation described above). With reference to FIG. 1, the system 10 includes a plasma torch 12 that is configured to create a plasma plume 14. The system 10 may further include a feeding mechanism 16 configured to contact the inorganic formulation 18 with the plasma plume 14. As shown in FIG. 1, the inorganic formulation 18 may be fed from above the plasma plume 14. In other embodiments, the feeding mechanism 16 is configured to feed the inorganic formulation from a side of or below the plasma plume. After contact with the plasma plume 14, the inorganic formulation 18 is fiberized into fibers 20. Although not shown, the system 10 may include a collecting mechanism, such as a mesh screen, for collecting the fibers 20.

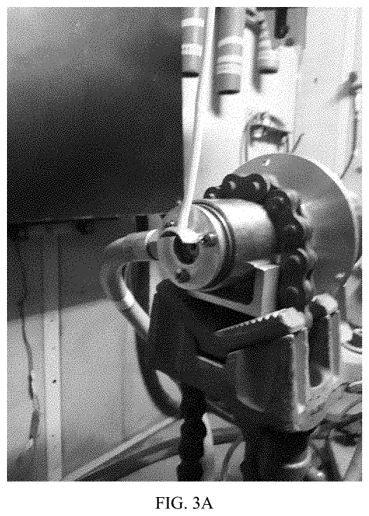

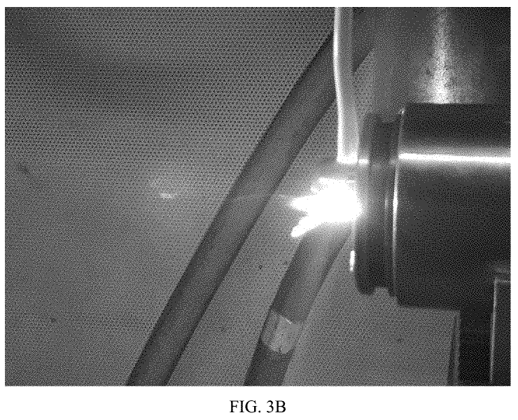

Referring to FIG. 3A, in some embodiments of the fiberization system, the plasma torch (a direct current (DC) arc torch is shown) may be fitted with an inorganic formulation feeding mechanism configured to bring the inorganic formulation (solid or liquid) into contact with the plasma plume. In FIG. 3A, the feeding mechanism is specially adapted for a rod or a multifilament to be fed into the plasma plume. In the embodiment shown in FIG. 3B, a rod made of the desired fiber chemistry is fed into the plasma plume. In other embodiments, a plurality of rods of varying compositions may be fed into the plasma plume. As one end of the rod or plurality of rods advances into contact with the high temperature zone of the plasma plume, the tip of the rods melts and the extremely high plume speed causes this liquid to atomize and attenuate into fibers.

In some embodiments, a collection device may be included in the fiberization system to collect the fibers as they are expelled from the plasma plume. For example, the collection device may include an air filter or mesh screen. In some embodiments, the gas supplied to the plasma torch and expelled in the plasma plume may be recycled and reused. In such embodiments, a recycling mechanism, such as a duct and fan, may be employed.

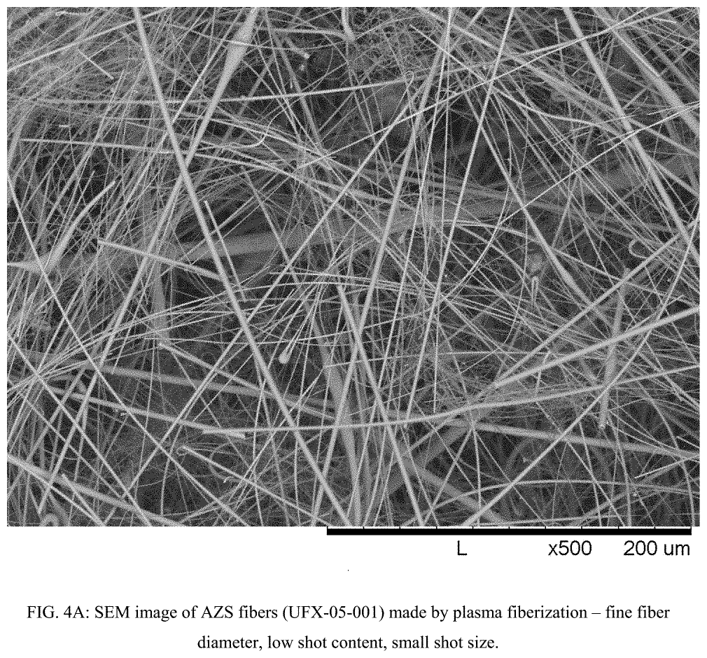

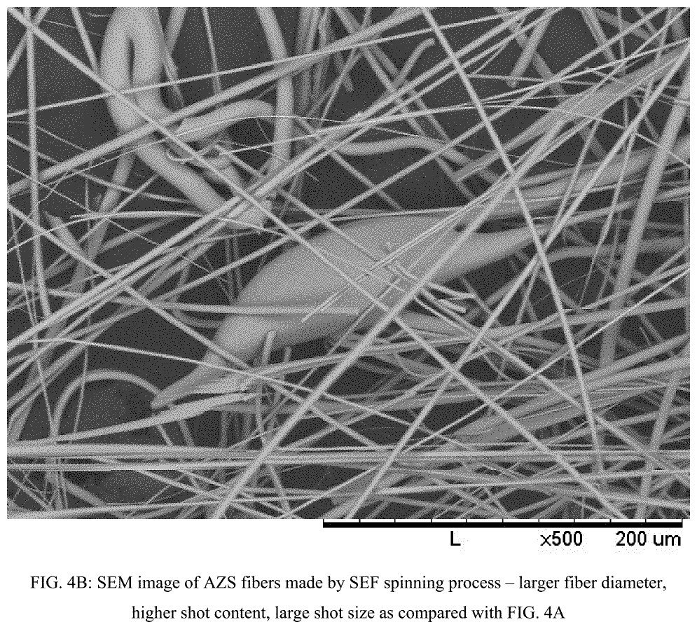

According to embodiments of the present disclosure, by using a plasma torch, a fiber with less non-fiberized material (shot or particulates) may be produced. The non-fiberized materials are not desired in the product, as they reduce the product performance, e.g. insulation value and mechanical strength. As shown in FIGS. 4A and 4B, for the same chemical composition, the fibers produced by plasma (FIG. 4A) contain less shot or particulates than that produced by external centrifuging method (FIG. 4B). For example, according to embodiments of the present disclosure, the fiber material may have a fiber index (weight of fiberized material/total weight of material that contains both fiber and shot) of at least 50%, at least 55%, at least 60%, at least 65%, at least 70%, at least 75%, at least 80%, at least 85%, at least 90%, or greater than 90%. As used herein, “fiberized material” is material consisting of fibers. In contrast, conventional fiber forming methods such as external centrifuging or air blowing yield a fiber index of about 50%.

### Example 1

A DC arc torch, as shown in FIG. 3A, was run at the operating conditions shown in Table 1 below:

TABLE 1
Test #1 Conditions and Parameters

| | Argon | Torch | Torch | Torch |
|---|---|---|---|---|
| | flow rate | Current | Voltage | Net Power |
| Run | (slpm) | (amps) | (Volts) | (kW) |
| Test #1, Run #1 | 285 | 125 | 87.6 | 6.4 |
| Test #1, Run #2 | 285 | 200 | 124 | 14.1 |
| Test #1, Run #3 | 245 | 200 | 114 | 12.4 |
| Test #1, Run #4 | 245 | 250 | 115 | 15.1 |
| Test #1, Run #5 | 335 | 250 | 130 | 16.2 |
| Test #1, Run #6 | 335 | 250 | 131 | 18.0 |
| Test #1, Run #7 | 335 | 250 | 131 | 18.0 |

“slpm” is standard liter per minute, i.e., gas flow rate at standard temperature and pressure.

For each of Runs 1-7 shown above, the enthalpy, temperature, and velocity of the plasma plume were measured. These results are summarized in Table 2 below:

TABLE 2

| | Plasma Enthalpy | Plasma T | Bulk velocity |
|---|---|---|---|
| Run | (J/Kg) | (K) | (m/s) |
| Test #1, Run #1 | 8.10E+05 | 1900 | 941 |
| Test #1, Run #2 | 1.78E+06 | 3750 | 1858 |
| Test #1, Run #3 | 1.82E+06 | 3800 | 1619 |
| Test #1, Run #4 | 2.22E+06 | 4600 | 1959 |
| Test #1, Run #5 | 1.74E+06 | 3650 | 2126 |
| Test #1, Run #6 | 1.94E+06 | 4050 | 2359 |
| Test #1, Run #7 | 1.94E+06 | 4050 | 2359 |

### Example 2

Inorganic formulations of AZS, calcia magnesia silicate (CMS), high purity silica, and B-glass were fiberized using a plasma torch under the conditions summarized in Table 3A below.

The fiber diameters were measured, and the results are shown in Table 3B.

TABLE 3A

| | | Fiberization conditions | | | | | | |
|---|---|---|---|---|---|---|---|---|
| | | | | | | | Plasma | |
| | | | | | Gross | Plasma bulk | bulk | |
| | | Nozzle | He | Ar | power, | temperature | velocity | Mach |
| Exp | Feeding materials | size | [slpm] | [slpm] | kW | [K] | [m/s] | Number |
| 1 | CaO—MgO—SiO2 rods, Ø7 mm | 3/16″ | 0 | 245 | 28 | 4600 | 1959 | 1.6 |
| 2 | CaO—MgO—SiO2 rods, Ø7 mm | 3/16″ | 0 | 50 | 16.2 | 8000 | 1262 | 0.8 |
| 3 | SiO2 glass rods, Ø5 mm | 3/16″ | 0 | 200 | 47.9 | 6700 | 4229 | 2.79 |
| 4 | CaO—MgO—SiO2 rods, Ø7 mm | 3/16″ | 0 | 200 | 47.9 | 6700 | 4229 | 2.79 |
| 5 | CaO—MgO—SiO2 rods, Ø7 mm | 3/16″ | 0 | 100 | 9.9 | 3000 | 947 | 0.93 |
| 6 | CaO—MgO—SiO2 rods, Ø7 mm | 3/16″ | 0 | 100 | 16 | 9300 | 2935 | 1.88 |
| 7-1 | SiO2 glass rods, Ø5 mm | ¼″ | 45 | 180 | 56.5 | 9500 | 3775 | 2.1 |
| 7-2 | SiO2 glass rods, Ø5 mm | | 100 | 125 | 73.9 | 11000 | 4371 | 2.13 |
| 8 | Attenuated SiO2 glass rods, | ¼″ | 0 | 225 | 49.2 | 8000 | 3179 | 2.01 |
| | Ø ~1.5 mm | | | | | | | |
| 8-1 | Attenuated SiO2 glass rods, | ¼″ | 60 | 165 | 58.1 | 9600 | 3815 | 2.13 |
| | Ø ~1.5 mm | | | | | | | |
| 9-1 | Al2O3—ZrO2—SiO2 rods, | ¼″ | 0 | 225 | 48.9 | 8100 | 3219 | 2.03 |
| | Ø7 mm | | | | | | | |
| 9-2 | Al2O3—ZrO2—SiO2 rods, | | 0 | 226 | 49.1 | 7900 | 3153 | 1.99 |
| | Ø7 mm | | | | | | | |
| 10 | SiO2 glass rods, Ø1.5 mm | ¼″ | 80 | 165 | | | | |
| 11-1 | SiO2 glass rods, Ø2 mm | ¼″ | 60-80 | 150-165 | 53.8-56.0 | 8400-9800 | 3300-4000 | 1.9-2.0 |
| 11-2 | SiO2 glass rods, Ø2 mm | ¼″ | 60-80 | 150-165 | 53.8-56.0 | 8400-9800 | 3300-4000 | 1.9-2.0 |
| 12-1 | SiO2 glass rods, Ø3 mm | ¼″ | 125 | 100 | 57.1-57.7 | 10100-10600 | 4000-4200 | 1.8 |
| 12-2 | SiO2 glass rods, Ø3 mm | ¼″ | 125 | 100 | 57.1-57.7 | 10100-10600 | 4000-4200 | 1.8 |
| 13 | B-glass rods, Ø7 mm | ¼″ | 125 | 100 | 57.7 | 10200 | 4100 | 1.8 |
| 14 | B-glass rods, Ø10 mm | ¼″ | 125 | 100 | 57.7 | 10200 | 4100 | 1.8 |

TABLE 3B

| | | Fiber diameter (μm) | | | |
|---|---|---|---|---|---|
| | | Arithemetic | | Geometric | Standard |
| Exp | Feeding materials | Mean | Median | mean | deviation |
| 1 | CaO—MgO—SiO2 rods, Ø7 mm | 2.78 | 1.82 | 2.00 | 2.49 |
| 2 | CaO—MgO—SiO2 rods, Ø7 mm | 3.51 | 2.53 | 2.58 | 2.71 |
| 3 | SiO2 glass rods, Ø5 mm | failed to fiberize | | | |
| 4 | CaO—MgO—SiO2 rods, Ø7 mm | 1.54 | 1.13 | 1.08 | 1.67 |
| 5 | CaO—MgO—SiO2 rods, Ø7 mm | failed to fiberize | | | |
| 6 | CaO—MgO—SiO2 rods, Ø7 mm | 2.28 | 1.49 | 1.55 | 2.37 |
| 7-1 | SiO2 glass rods, Ø5 mm | 1.49 | 0.74 | 0.86 | 1.86 |
| 7-2 | SiO2 glass rods, Ø5 mm | | | | |
| 8 | Attenuated SiO2 glass rods, | failed to fiberize | | | |
| | Ø ~1.5 mm | | | | |
| 8-1 | Attenuated SiO2 glass rods, | 1.23 | 0.52 | 0.70 | 1.95 |
| | Ø ~1.5 mm | | | | |
| 9-1 | Al2O3—ZrO2—SiO2 rods, | 1.43 | 0.97 | 0.94 | 1.59 |
| | Ø7 mm | | | | |
| 9-2 | Al2O3—ZrO2—SiO2 rods, | | | | |
| | Ø7 mm | | | | |
| 10 | SiO2 glass rods, Ø1.5 mm | 1.08 | 0.40 | 0.59 | 1.73 |
| 11-1 | SiO2 glass rods, Ø2 mm | 1.52 | 0.68 | 0.85 | 1.94 |
| 11-2 | SiO2 glass rods, Ø2 mm | 1.40 | 0.61 | 0.77 | 2.08 |
| 12-1 | SiO2 glass rods, Ø3 mm | 1.49 | 0.71 | 0.85 | 1.75 |
| 12-2 | SiO2 glass rods, Ø3 mm | 1.36 | 0.62 | 0.78 | 1.69 |
| 13 | B-glass rods, Ø7 mm | 1.58 | 0.97 | 1.00 | 1.68 |
| 14 | B-glass rods, Ø10 mm | 1.87 | 1.36 | 1.22 | 1.80 |

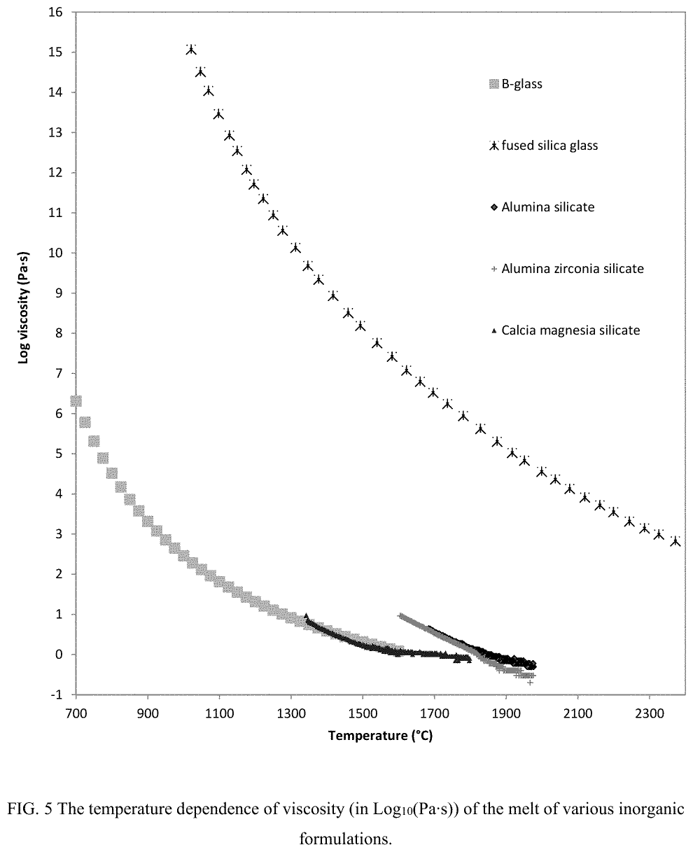

As shown in FIG. 5, AZS, CMS, high-purity silica, and B-glass have very distinct melt and viscosity characteristics. In particular, the melt of the calcia magnesia silicate mix used in Example 2 solidifies rapidly at about 1300° C. It also has a strong crystallization tendency at or below its liquidus temperature, and therefore the viscosity curve is disrupted at about 1300° C., as seen in FIG. 5. Similarly, the melt of the alumina zirconia silicate mix used in Example 2 solidifies rapidly at about 1600° C., and its viscosity curve does not extend much beyond its liquidus temperature. Both melts have high liquidus and solidus temperatures (1200-1700° C.), their viscosities at these temperature points are low (i.e., less than 100 poise), and both tend to solidify/crystalize rapidly at such temperature. As seen in Table 3 above, an inorganic formulation with such melt and viscosity behavior can be readily melted and fiberized by the plasma method described herein. In Table 3, both the CMS and AZS mixes had been melted and fiberized by plasma with only Ar.

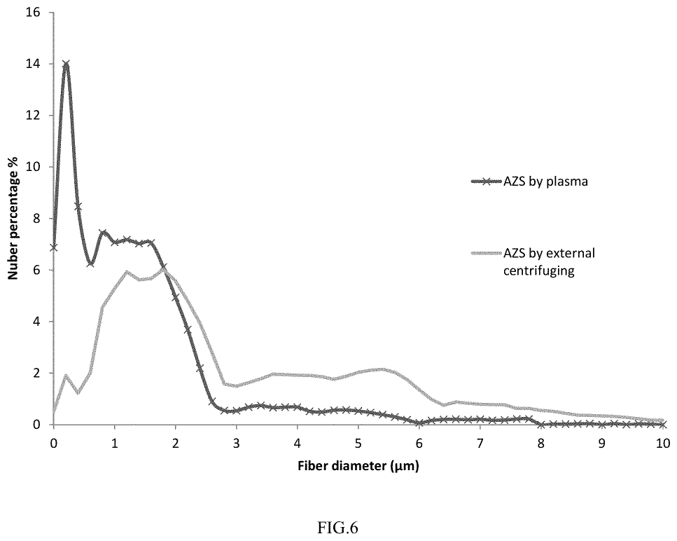

Compared to the conventional fiberization method, the method of the present disclosure produces fibers of finer diameter and narrower distribution. For instance, in Table 4 below, AZS fibers made by plasma and external centrifuging are compared in diameter, and the fiber diameter for fibers made by plasma is less than half of that by external centrifuging. The fibers made by the plasma method also have a much smaller standard deviation of fiber diameter, indicating a much narrower fiber diameter distribution, also clearly seen in FIG. 6.

TABLE 4

| | | Fiber diameter (μm) | | | |
|---|---|---|---|---|---|
| Fiberization | Feeding | Arithmetic | | Geometric | Std |
| methods | materials | mean | Median | mean | deviation |
| Plasma | Ø8 mm AZS | 1.42 | 1.00 | 1.02 | 1.53 |
| fiberization | rods | | | | |
| External | AZS melt | 3.30 | 2.26 | 2.44 | 2.61 |
| centrifuging | stream | | | | |

### Example 3

In addition to the high-purity silica fibers produced in Example 2 above, high-purity silica fibers were produced using flame attenuation with an oxyhydrogen flame and using acid leaching. The conditions of these processes are shown in Table 5 below. As discussed herein, due to the very high melting temperature and high viscosity of silica, the flame attenuation method requires first producing fine (less than 500 microns) filaments of silica, e.g., quartz glass. According to the acid leaching process, microfibers having a different chemistry of poor chemical durability, i.e., not pure silica, must first be produced and then leached in hot acid to remove the impurities therefrom. On the other hand, the present method obviates such preliminary process steps. Rather, as shown below, despite starting with 1.5 mm diameter quartz rods, the plasma fiberization method was able to produce fibers having a geometric mean less than half that of either the flame attenuated fibers or the acid leached fibers. Of note, if such 1.5 mm quartz rods were to be introduced to an oxyhydrogen flame, the material would merely melt and would not fiberize.

TABLE 5

| | | Fiber diameter (μm) | | | |
|---|---|---|---|---|---|
| Fiberization | Feeding | Arithmetic | | Geometric | Std |
| methods | materials | mean | Median | mean | deviation |
| Plasma | 1.5 mm diameter | 1.23 | 0.52 | 0.70 | 1.95 |
| fiberization | quartz glass rods | | | | |
| Oxyhydrogen | <500 μm diameter | 2.70 | 2.37 | 1.87 | 2.00 |
| flame attenuation | quartz glass filaments | | | | |
| Acid leached | <3 μm diameter | 2.60 | 2.20 | 1.74 | 2.07 |
| glass microfiber | microfiber | | | | |

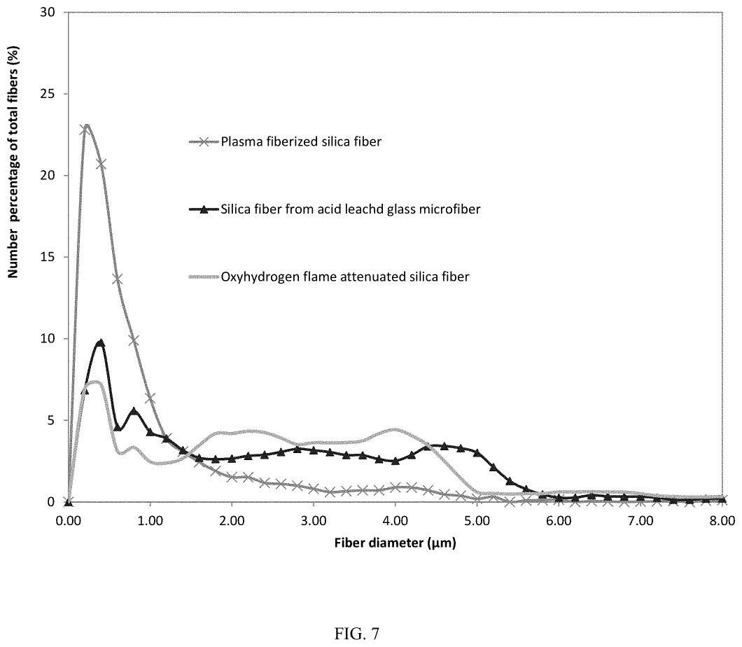

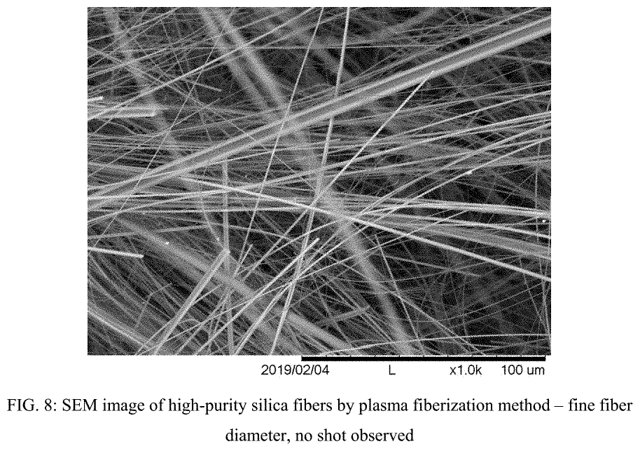

In addition, the diameter distribution curves for each of the samples are shown in FIG. 7. As is clear in FIG. 7, a large majority of the fibers produced by plasma fiberization were tightly concentrated in a diameter range of between 0 and 1 microns. On the other hand, the flame attenuated fiber and acid leached fibers were rather evenly distributed in a diameter range of from 0.2 to 5 microns. FIG. 8 also demonstrates that the plasma fiberization method was able to achieve fine fiber diameter with no shot observed.

Although the present disclosure has been described using preferred embodiments and optional features, modification and variation of the embodiments herein disclosed can be foreseen by those of ordinary skill in the art, and such modifications and variations are considered to be within the scope of the present disclosure. It is also to be understood that the above description is intended to be illustrative and not restrictive. Many alternative embodiments will be apparent to those of ordinary skill in the art upon reviewing the above description. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the disclosure.

What is claimed is:

1. A method of producing fibers comprising:
exposing an inorganic composition to a plasma plume,
wherein the plasma plume has a temperature of at least 1500° C. and a bulk velocity of at least 350 m/s.

2. The method according to claim 1, wherein the fibers comprise alumina silicate, alumina zirconia silicate, alkaline earth silicate, alkali alumina silicate, B-glass, C-glass, or E-glass.

3. The method according to claim 1, wherein exposing the inorganic composition to the plasma plume forms the fibers, the fibers comprising fiberized material and unfiberized material; and
wherein the fibers have a fiber index of at least 50%, the fiber index being equal to a weight of the fiberized material divided by a total weight of the fiberized material and the unfiberized material.

4. The method according to claim 1, wherein exposing the inorganic composition comprises introducing a single rod, a multifilament, or a melted stream of the inorganic composition to the plasma plume.

5. The method according to claim 1, wherein the inorganic composition comprises high-purity silica.

6. The method according to claim 1, wherein exposing the inorganic composition comprises exposing solid silica having a silica content of greater than 99% by weight to the plasma plume;
wherein the fibers have a geometric mean fiber diameter of less than 1 μm.

7. The method according to claim 6, wherein the solid silica is in the form of silica rods having a diameter of greater than 1 mm.

8. A system for producing fibers, comprising:
a plasma torch configured to produce a plasma plume; and
a feeding device configured to introduce an inorganic composition to the plasma plume;
wherein the plasma plume has a temperature of at least 1500° C. and a bulk velocity of at least 350 m/s.

9. The system according to claim 8, wherein the inorganic composition comprises a single rod, a multifilament, or a melted stream.

10. The system according to claim 8, wherein the fibers have a geometric mean fiber diameter of less than 4 μm.

11. The system according to claim 10, wherein the inorganic composition comprises high-purity silica in the form of silica rods having a diameter of greater than 1 mm.

12. The system according to claim 8, wherein introducing the inorganic composition to the plasma plume forms fibers containing fiberized material and unfiberized material; and
wherein the fibers have a fiber index of at least 50%, the fiber index being equal to a weight of the fiberized material divided by a total weight of the fiberized material and the unfiberized material.

13. The system according to claim 8, wherein the fibers comprise alumina silicate, alumina zirconia silicate, alkaline earth silicate, alkali alumina silicate, B-glass, C-glass, or E-glass.

14. A method of producing fibers, comprising simultaneously melting, atomizing and attenuating an inorganic formulation by exposing the inorganic formulation to a high temperature and high velocity plasma plume.

15. The method according to claim 14, wherein the inorganic formulation is of uniform composition.

16. The method according to claim 14, wherein the inorganic formulation is a mechanically mixed combination of distinct components.

17. The method according to claim 14, wherein the inorganic formulation is a solid silicate glass rod or a multifilament.

18. The method according to claim 17, wherein the solid silicate rod or multifilament comprises a silicate glass composition.

19. The method according to claim 18, wherein the silicate glass composition is B-glass, C-glass, or E-glass.

20. The method according to claim 14, wherein the plasma plume has a temperature of at least 1500° C. and a bulk velocity of at least 350 m/s.
